(19) United States
(12) Patent Application Publication
(10) Pub. No.: US 2015/0068103 A1
(43) Pub. Date: Mar. 12, 2015

(54) Planer Board Fishing Quick Line Roller

(71) Applicant: Euclide Cecchin, Windsor (CA)

(72) Inventor: Euclide Cecchin, Windsor (CA)

(21) Appl. No.: 14/297,803

(22) Filed: Jun. 6, 2014

(51) Int. Cl. A01K 91/047; A01K 97/00

(52) U.S. Cl. CPC A01K 91/047; A01K 97/00
USPC 43/27.2

(57) ABSTRACT

The Planer Board Fishing Quick Line Roller is a pulley system created to improve planer board and mast line fishing. The pulley represents an entirely new device to improve the process for fishermen to utilize gravity to position the fishing line release in the desired location along a mast line. When the fishing line release is triggered by fish strike or snag, the pulley system effortlessly glides down the line with the release attached, all the way down to the planar board allowing the next pulley and release to be attached and the fishing can continue without the worry of the previous release clip hindering the performance or location of the subsequent release clip. Additionally, the Planer Board Fishing Quick Line Roller utilizes the fisherman's original equipment, such as a Planer Board Release or other commercially available devices using the “shower curtain clip”.

### CROSS-REFERENCE TO RELATED APPLICATIONS

There are no Related Applications

### STATEMENT REGARDING FEDERALLY SPONSORED RESEARCH OR DEVELOPMENT

There is No Federally Sponsored Research or Development

### THE NAMES OF THE PARTIES TO A JOINT RESEARCH

The inventor is Mr. Euclide Cecchin of Windsor, Ontario, Canada

Reference to a “Sequence Listing,” a table or computer program listing appendix submitted on compact disc and an incorporation-by-reference of the material on the compact disc.

This is Not Applicable to the Patent application for the Planer Board Fishing Quick Line Roller

### STATEMENT REGARDING PRIOR DISCLOSURES BY AN INVENTOR OR JOINT INVENTOR

This is Not Applicable to the Patent Application for the Planer Board Fishing Quick Line Roller

### TRADEMARK PENDING, AUTHORIZATION

A portion of the disclosure of this patent document contains material which is subject to Trademark (“Planer Board Fishing”) protection. The trademark owner has no objection to the facsimile reproduction by anyone of the patent document or the patent disclosure, as it appears in the Patent and Trademark Office patent file or records, but otherwise reserves all trademark rights whatsoever.

### BACKGROUND OF THE INVENTION

1) Field of invention

This invention concerns accessories for fishing (Class 43, subclass—4.5, 25.2), particularly accessories for use with a positioning line (or release line), i.e., a line that does not carry a fishing lure but instead is used to position the fishing line (that does carry the fishing lure) in the water. Examples of such positioning lines are surface planer board lines and mast lines.

2) Background of the Invention

Was invented by Mr. Euclide Cecchin, of Windsor, Ontario, Canada. The invention is a plastic roller pulley used to transport fishing tackle along a mast line that spans between a fishing boat and a floating board that planes through the water at a controlled distance.

One method of fishing involves the use of a planer board system. In this method, a planer board is sent out from the side of the boat on the surface of the water. A positioning line or mast line secures the planer board to the boat. The positioning line angles from the boat at an angle less than 90 degrees. The fishing lines are then attached with a release mechanism to the positioning line and slid out on that line to the desired distance away from the boat.

When a fisherman attaches a “shower curtain” clip or other release mechanism to a mast line and the fishing line is attached to the release clip, the fisherman is able to release line off the reel allowing the clip and release to slide down the planar board mast line. This sliding action causes friction and the clip can get hung up or stuck along the way to its final destination, the planar board. The fisherman in this method is required to shake the fishing rod to free up the shower curtain clip to get the clip to proceed along the mast line out and away from the boat. The shaking introduces the risk of the actual fishing line being pulled from the release clip and the process would have to be started all over with the original clip possibly stuck in a position preventing it from reaching the final destination.

While various devices exist utilizing a shower curtain clip or variation as part of a line release, all current devices create friction and difficulty in reaching the final destination along the mast line. There is a need for an improved method of transporting the board line release, and the apparatus and its pulley system prevents the friction or becoming stuck resulting in smooth control by the fisherman increasing the ability to position the fishing line release in the desired location along the mast line. This benefit also improves when a fishing line release is triggered, either by a fish strike or a snack, as the pulley system of the apparatus glides down the line with the release attached all the way down to the planar board which allows the next pulley and release to be attached without the worry of the released clip hindering the performance and location of the subsequent release clip.

### SUMMARY OF THE INVENTION

The invention is an apparatus for improving the fisherman's ability to control and position a release system along a planer board line or mast line. The invention may be achieved in several embodiments. In general terms, the invention utilizes a pulley technology to enhance the ease at which a release or other device travels down a mast or planer board line to the planer board for fishing. This enables the invention to glide without sticking or excess resistance to the desired position increasing the fisherman's control over the release travelling toward the planer board.

The invention can attach to many of the existing market fishing line releases and improve upon the primitive method of the fisherman jerking the release clip out along the planer board mast line with virtually no control.

### BRIEF DESCRIPTION OF SEVERAL VIEWS OF THE DRAWING (INVENTION)

The accompanying drawings illustrate the invention, its dimensions, and the principles of the invention in the context of particular embodiments of the invention. Thus, such embodiments are examples, and they are not intended to limit the scope of the invention except as specifically stated further below.

FIG. 1

Schematic diagrams of one embodiment of the invention, Top View of Planer Board Fishing Quick Line Roller—ABS Casing—Dimensions are 6 cm (2.36 inches)×4.5 cm (1.77 inches)×1.5 cm (0.59 inches).

The invention comes in multiple colours including: red, green, turquoise, orange, yellow, blue, and white,

FIG. 2

Schematic diagrams of one embodiment of the invention, Top View of the assembled Planer Board Fishing Quick Line Roller

FIG. 3

Schematic diagrams of one embodiment of the invention, Bottom side of the assembled Planer Board Fishing Quick Line Roller

FIG. 4

Schematic diagrams of one embodiment of the invention, Side Angle view of the Main Housing made of ABS Plastic. Figure shows measurements of a embodiment of the Main Housing

FIG. 5

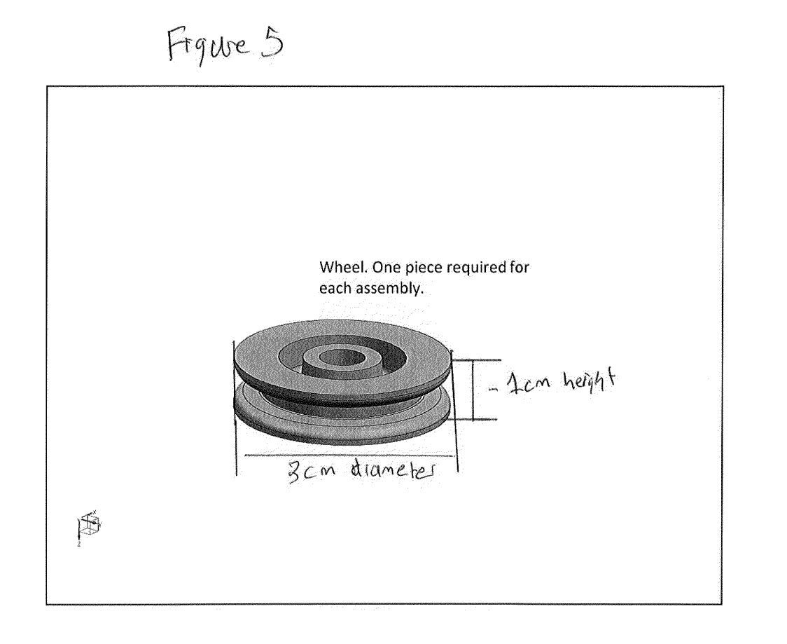

Schematic diagrams of one embodiment of the invention, ABS Plastic Wheel required for Planer Board Fishing Quick Line Roller. Dimensions of 3 cm diameter×1 cm height. One wheel required for each pulley.

FIG. 6

Schematic diagrams of one embodiment of the invention, ABS Plastic Retainer pin for Planer Board Fishing Quick Line Roller. Two Retainer pins/pulley, each with identical measurements of 2.5 cm×1 cm as shown in Figure

FIG. 7

Schematic diagrams of one embodiment of the invention, Assembly of the Planer Board Fishing Quick Line Roller. Step 1, Slide wheel into housing until hole in wheel lines up with hole in housing. Step 2: Install pin through housing and wheel until clip engages on the opposite side of the housing, Step 3: Install pin through housing until clip engages on the opposite side of the housing.

FIG. 8

Schematic diagrams of one embodiment of the invention, Lid and Base Assembly used for packaging seven Planer Board Fishing Quick Line Rollers. Packaging is used for sale of invention. Dimensions include 14 cm diameter×3 cm height. Top view and side profile views demonstrated

FIG. 9

Schematic diagrams of one embodiment of the invention, Base of packaging for sale of Planer Board Fishing Quick Line Rollers

FIG. 10

Schematic diagrams of one embodiment of the invention, Lid of packaging for sale of Planer Board Fishing Quick Line Rollers

FIG. 11

Schematic diagrams of one embodiment of the invention, Top view of Lid and Base Assembly packaging with empty clear, transparent container

FIG. 12

Schematic diagrams of one embodiment of the invention, Top view of Lid and Base Assembly packaging with seven Planer Board Fishing Quick Line Rollers inside. Transparent clear container, with various coloured Planer Board Fishing Quick Line Roller inventions inside.

FIG. 13

Actual photo of one embodiment of the invention—Planer Board Fishing Quick Line Roller attached to a commercially available example, the “Planer Board Release No. 1177” made by Scotty, typically used in mast line fishing.

FIG. 14

Actual photo of one embodiment of the invention—Planer Board Fishing Quick Line Roller positioned next to a ruler to provide scale of invention

### DETAILED DESCRIPTION OF THE INVENTION

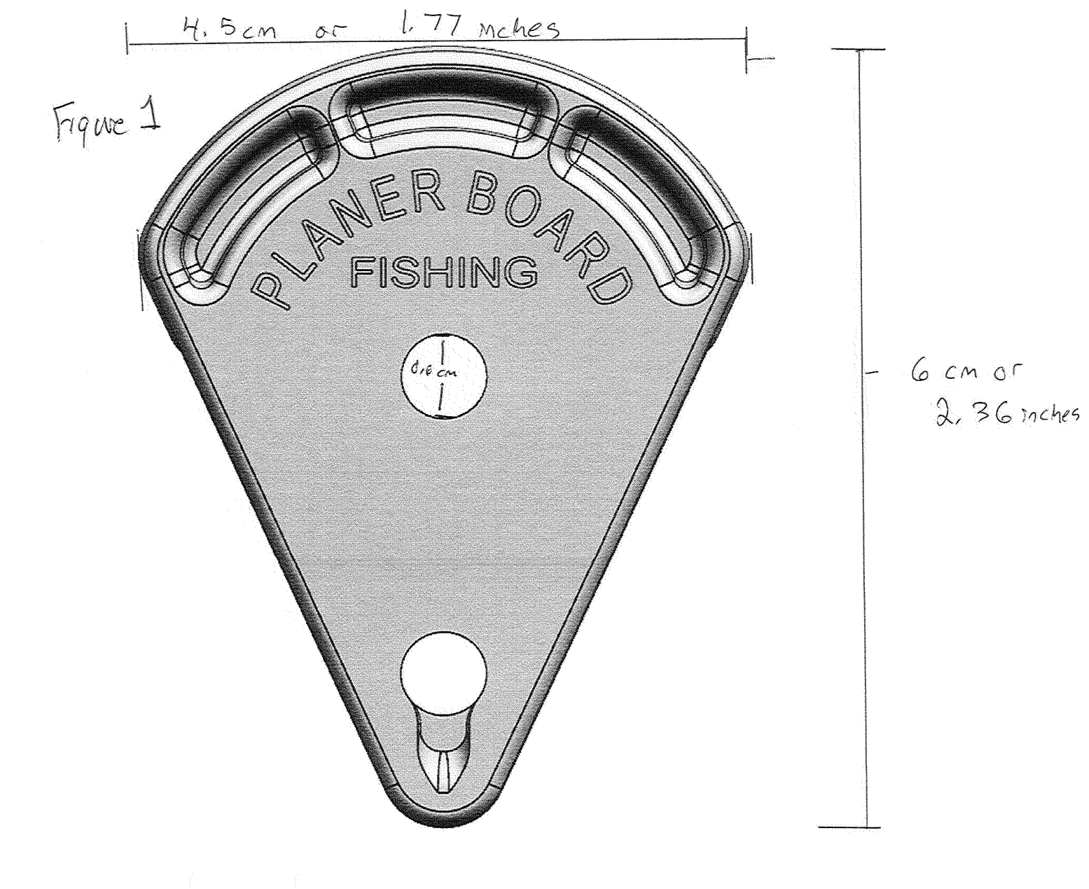

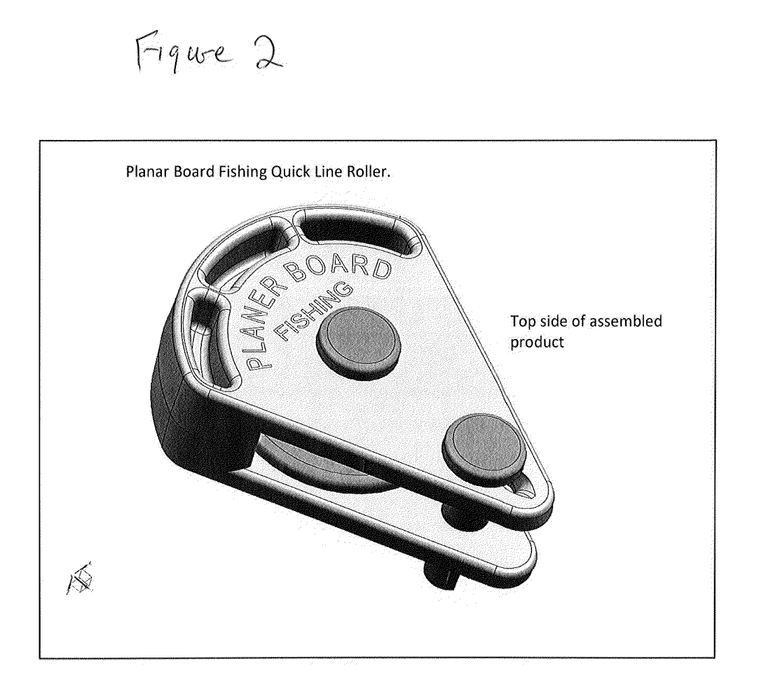

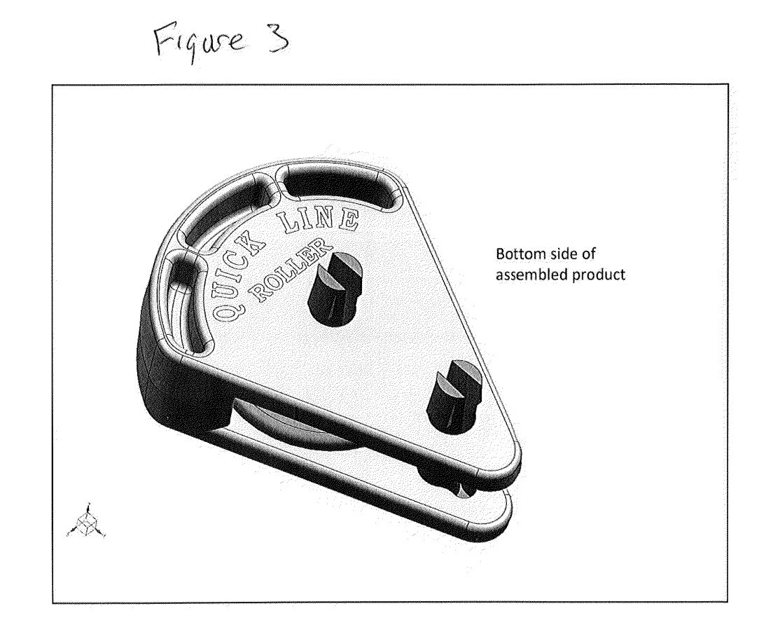

As depicted in schematic diagrams (FIG. 1-3) the invention consists of an embodiment including a housing, a wheel, and two collapsible pins. The invention includes an embodiment that is made of ABS plastic. The machines used to create one embodiment of the invention include a Horizontal Milling Machine and a Small Surfacing Machine.

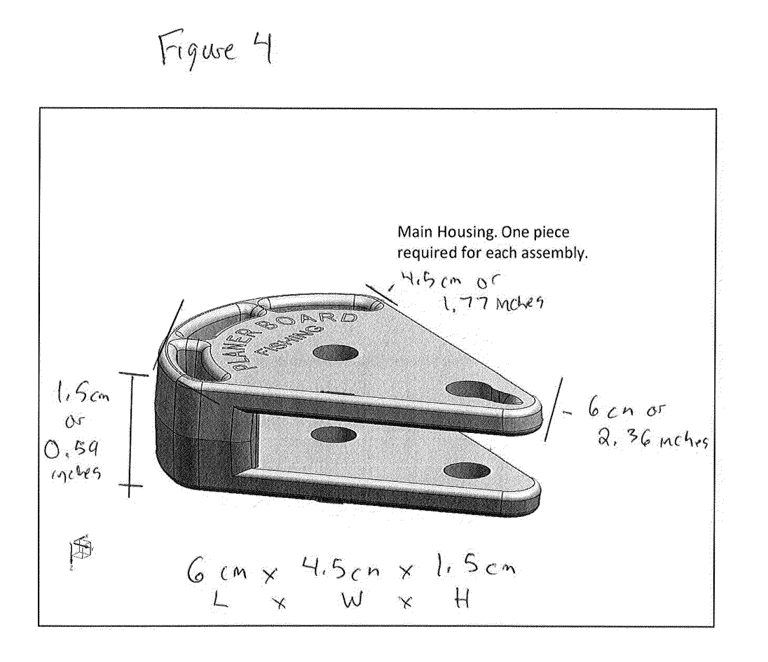

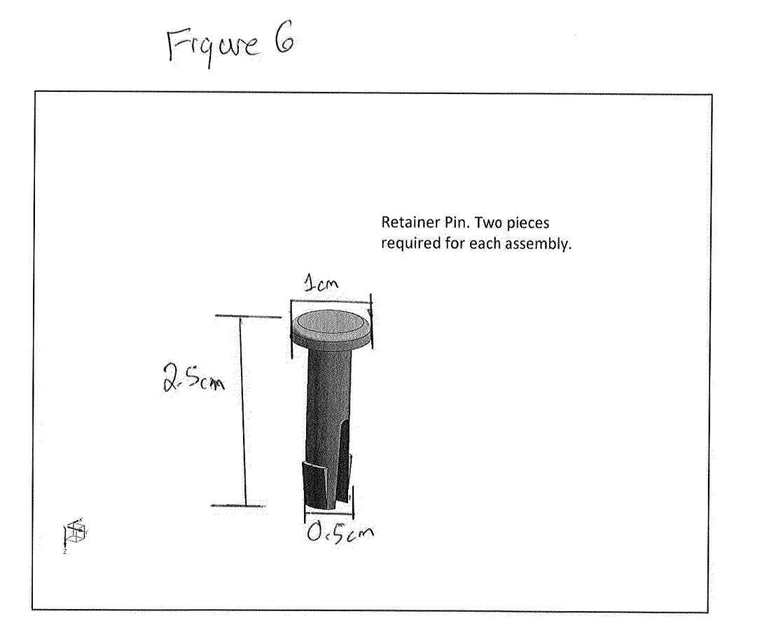

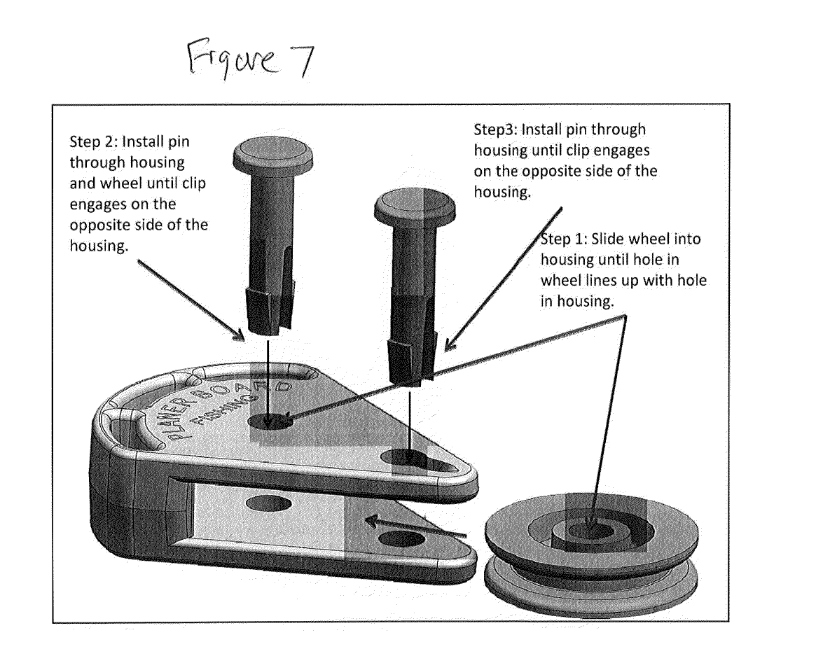

The schematic diagram in FIG. 4 illustrates the ABS Wheel (3 cm diameter (1.2 inches)×1 cm height (0.4 inches)) which is placed inside the housing (FIG. 1 and FIG. 4) (6 cm (2.36 inches)×4.5 cm (1.77 inches)×1.5 cm (0.59 inches)). Two holes (of 0.6 cm) are created in the housing (FIG. 1) which allow two pins to be inserted to hold the wheel for pulley function. The pin is illustrated in a schematic diagram in FIG. 6. FIG. 7 demonstrates the process of lining up the holes in the housing with the hole in the wheel. Step 1 of assembly, the wheel is inserted into the housing until the hole in the wheel lines up with the hole in the housing (FIG. 7). Step two indicates one of the pins is inserted through the housing and wheel and will expand on the opposite side of the housing clipping into position (FIG. 7). Step 3: Installing the second pin through the second hole in the bottom (narrow end) of the housing for attachment to the line clip (FIG. 7). Each pin is 2.5 cm (1 inch)×1 cm (0.4 inch) in measurement (FIG. 6). The process of assembly is show in schematic diagram in FIG. 7. The invention may contain future iterations, designs, shapes or materials.

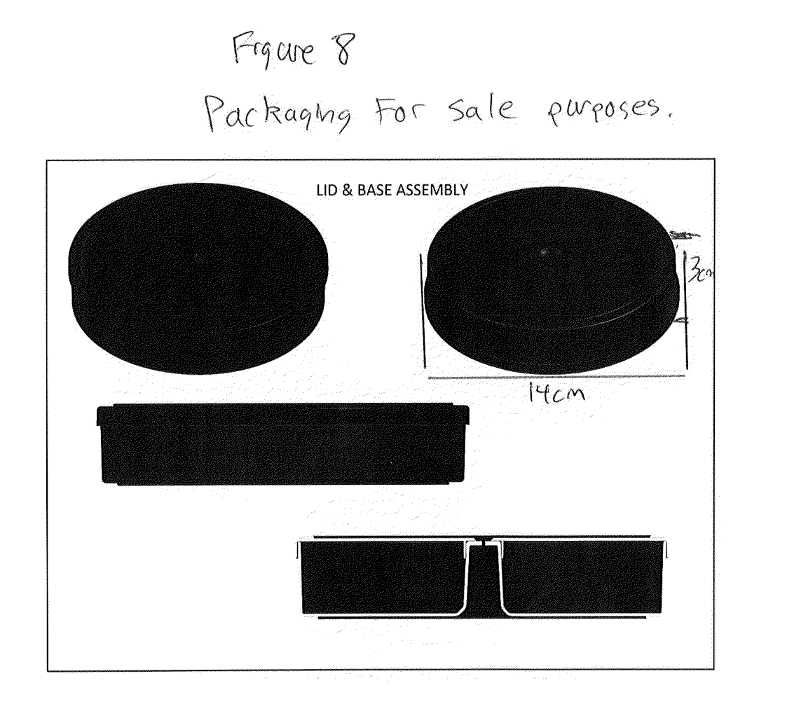

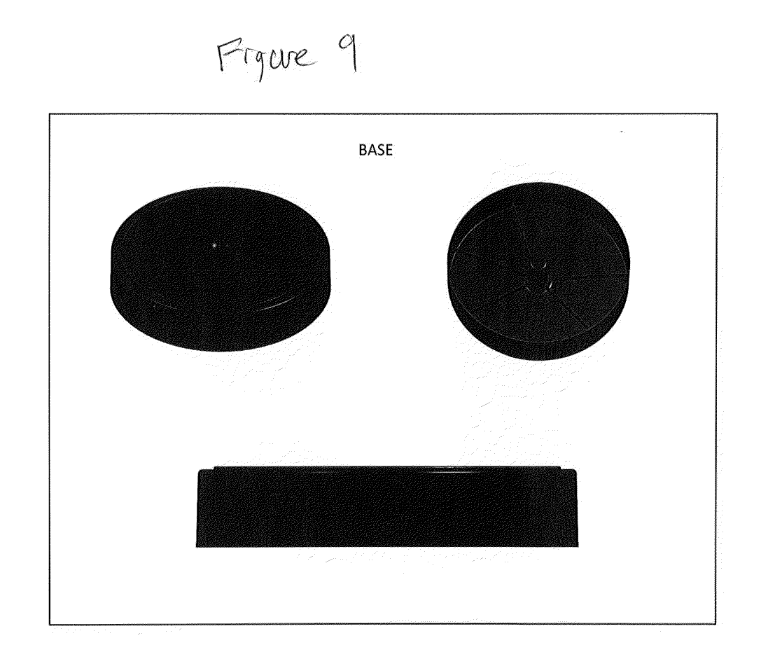

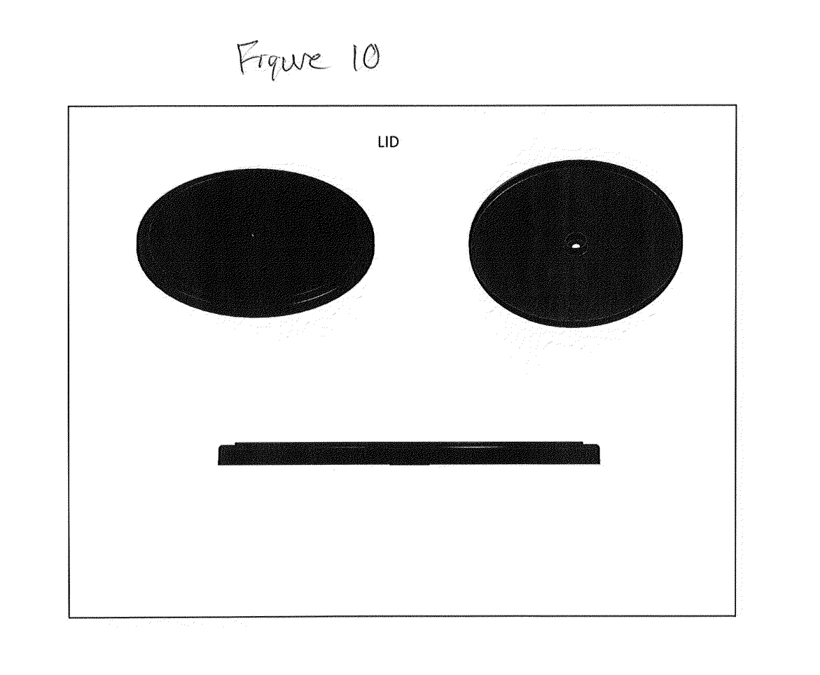

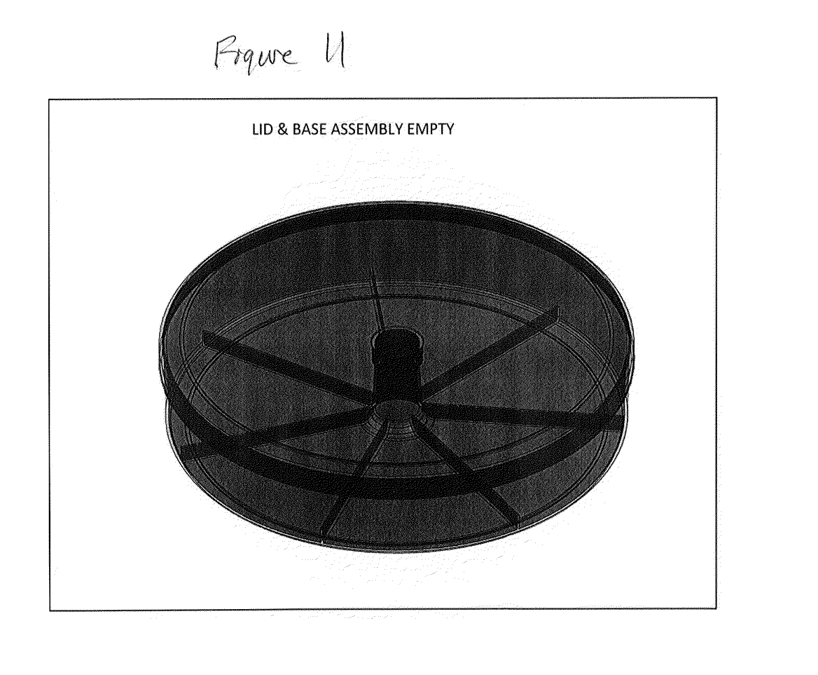

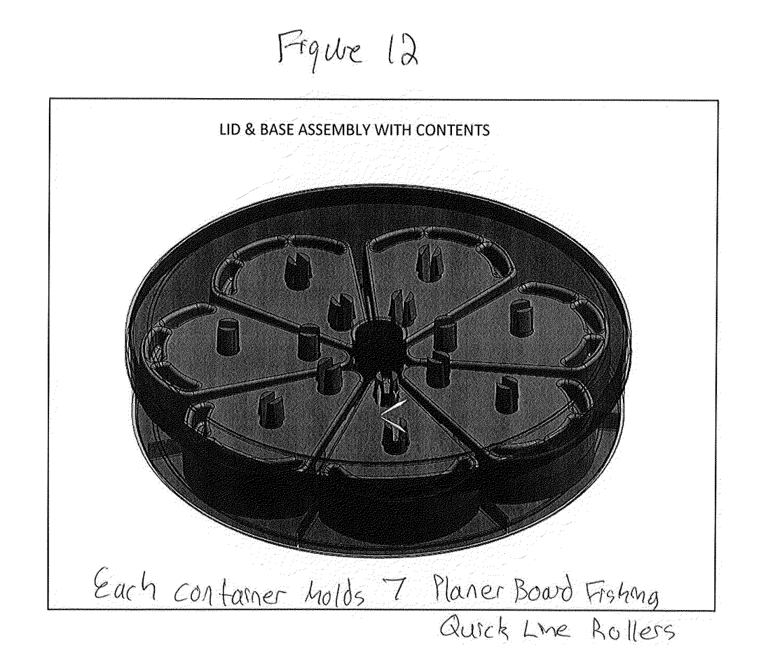

FIGS. 8-12 demonstrate the packaging used to sell the invention. The container consists of a lid and base assembly (FIGS. 8, 9, 10 and 11). FIG. 12 demonstrates each container holds seven inventions or apparatus. Future packaging or contains may take various designs or shapes. This embodiment is made of plastic and is transparent.

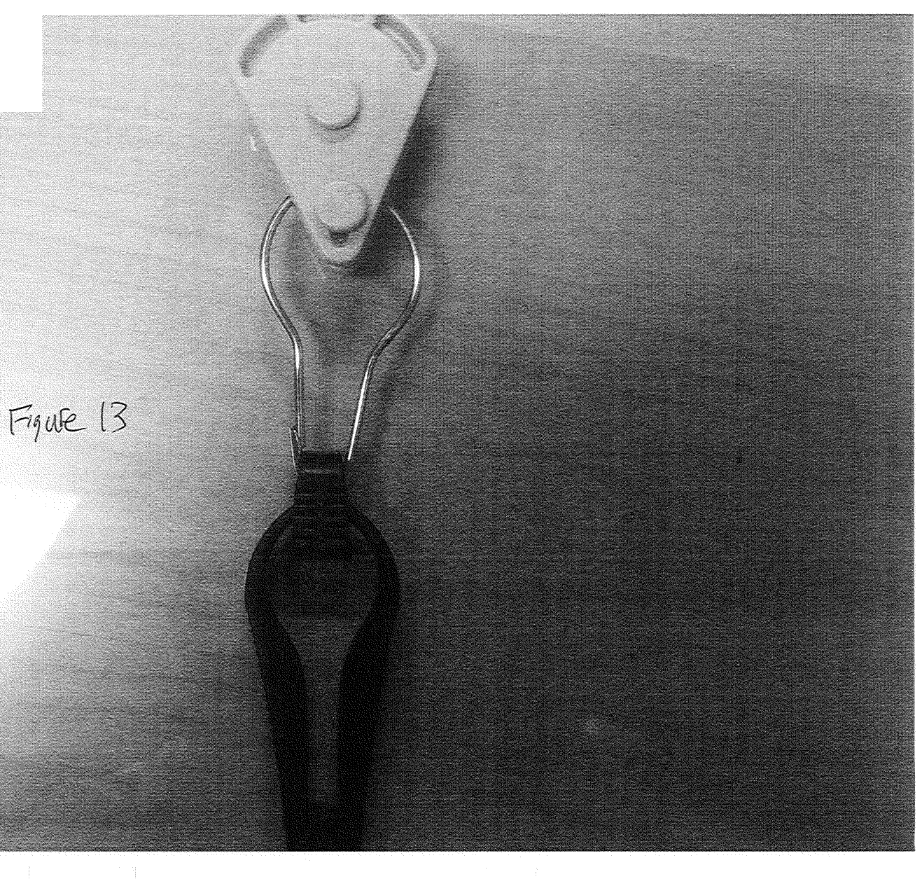

FIG. 13 depicts the invention attached to a commercially available example, the “Planer Board Release No. 1177” made by Scotty, typically used in mast line fishing. The invention can attach to many commercially available products to improve the fisherman's ability to control a fishing release in planer board or mast line or other types of fishing.

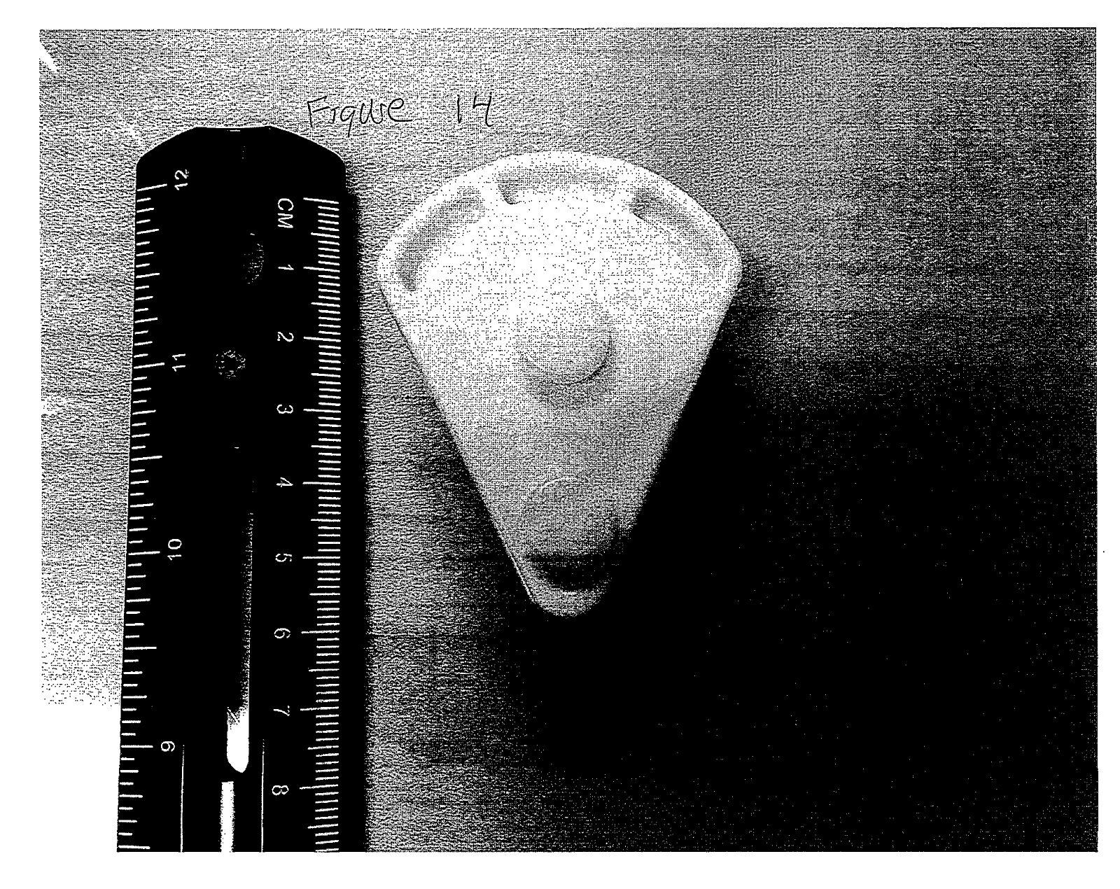

FIG. 14 illustrates the invention positioned next to a rule to provide scale of an embodiment of the invention.

The invention improves the efficiency of the entire planer board fishing system. Once the planar board is set up in its desired location, the pulley is attached to the planar board mast line. The original “shower curtain” clip with the fishing line release is then attached to the pulley. Once the fishing line is attached to the release, the fisherman can now release line off of the reel and the pulley system smoothly glides down the mast line with no friction or resistance at all. The pulley does not get hung up (stuck) anywhere on the mast line and the fisherman simply stops the spooling line from the reel whenever the desired position is reached along the mast line with no risk of setting off the fishing line release from the shaking operation explained in the “shower curtain” clip or other fishing release system.

Imagine a clothes line pulley gliding along the line as opposed to dragging a clothes pin along the line. The same principle applies. The invention utilizes a pulley system creating a substantial advantage over the original system or other commercially available, but different, products. The apparatus is a smoother more efficient way of positioning the fishing line release in the desired location along the mast line. There is no friction or sliding motion which eliminates any wear on the mast line itself which is expensive to replace and even more costly if it wears through or breaks and all the tackle is lost.

When the fishing line release is triggered, either by a fish strike or a snag or otherwise, the light weight pulley system effortlessly glides down the line with the release attached all the way down to the planar board which allows the next pulley and release to be attached and fishing can commence without the worry of the released clip hindering the performance and location of the next one. Nothing is stuck in the way.

1. The apparatus for attachment between a planar board line or mast line and a “shower curtain” clip or planer board release. The apparatus is a pulley containing an embodiment of a wheel, pins, and house or casing that allows a fisherman to seamlessly control the positioning of the clip or release along the mast line.

2. The apparatus of claim 1, in which the device used to control the shower curtain clip, planer board release, or similar device, operates as a pulley or pulley system.
